(19) United States
(12) Patent Application Publication
(10) Pub. No.: US 2023/0115563 A1
(43) Pub. Date: Apr. 13, 2023

(54) Method for a telepresence system

(71) Applicant: Teknologian tutkimuskeskus VTT Oy, Espoo (FI)

(72) Inventor: Seppo Valli, VTT (FI)

(21) Appl. No.: 17/787,960

(22) PCT Filed: Dec. 14, 2020
(86) PCT No.: PCT/FI2020/050839

§ 371 Date: Jun. 22, 2022

(30) Foreign Application Priority Data
Dec. 23, 2019 (FI) 20196130

(51) Int. Cl. H04N 13/282; G06T 7/55; G06T 3/40; H04N 13/111; H04N 13/194; H04N 13/366; H04N 13/332

(52) U.S. Cl. CPC H04N 13/282; G06T 7/55; G06T 3/4038; H04N 13/111; H04N 13/194; H04N 13/366; H04N 13/332; G06T 2207/10016; G06T 2207/10028

(57) ABSTRACT

There is provided a method comprising: receiving, at a local site, one or more perspective video-plus-depth streams from one or more remote sites, the video-plus-depth streams comprising video data and corresponding depth data from a viewpoint of a user at the local site; decoding the one or more perspective video-plus-depth streams; receiving a unified virtual geometry determining at least positions of participants at the local site and the one or more remote sites; forming a combined panorama based on the decoded one or more perspective video-plus-depth streams and the unified virtual geometry; and forming a plurality of focal planes based on the combined panorama and the depth data.

### FIELD

Various example embodiments relate to telepresence systems.

### BACKGROUND

Videoconference is an online meeting, where people may communicate with each other using videotelephony technologies. These technologies comprise reception and transmission of audio-video signals by users, e.g. meeting participants, at different locations. Telepresence videoconferencing refers to higher level of videotelephony, which aims to give the users the appearance of being present at a real world location remote from one's own physical location.

### SUMMARY

According to some aspects, there is provided the subject-matter of the independent claims. Some embodiments are defined in the dependent claims. The scope of protection sought for various embodiments is set out by the independent claims. The embodiments, examples and features, if any, described in this specification that do not fall under the scope of the independent claims are to be interpreted as examples useful for understanding various embodiments.

According to a first aspect, there is provided a method comprising: receiving, at a local site, one or more perspective video-plus-depth streams from one or more remote sites, the video-plus-depth streams comprising video data and corresponding depth data from a viewpoint of a user at the local site; decoding the one or more perspective video-plus-depth streams; receiving a unified virtual geometry determining at least positions of participants at the local site and the one or more remote sites; forming a combined panorama based on the decoded one or more perspective video-plus-depth streams and the unified virtual geometry; and forming a plurality of focal planes based on the combined panorama and the depth data.

According to a second aspect, there is provided a method comprising capturing a plurality of video-plus-depth streams from different viewpoints towards a user at a local site, the video-plus-depth streams comprising video data and corresponding depth data; receiving a unified virtual geometry determining at least positions of participants at the local site and one or more remote sites; forming, in response to a request received from the one or more remote site, perspective video-plus-depth streams from a viewpoint of a user of the one or more remote site based on the captured video-plus-depth streams and the unified virtual geometry; and transmitting the perspective video-plus-depth streams to the one or more remote sites and/or to a server; or forming a multi-view-plus-depth stream based on the perspective video-plus-depth streams and transmitting the multi-view-plus-depth stream to a server.

According to a third aspect, there is provided an apparatus comprising means for receiving, at a local site, one or more perspective video-plus-depth streams from one or more remote sites, the video-plus-depth streams comprising video data and corresponding depth data from a viewpoint of a user at the local site; decoding the one or more perspective video-plus-depth streams; receiving a unified virtual geometry determining at least positions of participants at the local site and the one or more remote sites; forming a combined panorama based on the decoded one or more perspective video-plus-depth streams and the unified virtual geometry; and forming a plurality of focal planes based on the combined panorama and the depth data.

According to a fourth aspect, there is provided an apparatus comprising means for capturing a plurality of video-plus-depth streams from different viewpoints towards a user at a local site, the video-plus-depth streams comprising video data and corresponding depth data; receiving a unified virtual geometry determining at least positions of participants at the local site and one or more remote sites; forming, in response to a request received from the one or more remote site, perspective video-plus-depth streams from a viewpoint of a user of the one or more remote site based on the captured video-plus-depth streams and the unified virtual geometry; and transmitting the perspective video-plus-depth streams to the one or more remote sites and/or to a server; or forming a multi-view-plus-depth stream based on the perspective video-plus-depth streams and transmitting the multi-view-plus-depth stream to a server.

According to fifth aspect, there is provided an optionally non-transitory computer readable medium comprising program instructions that, when executed by at least one processor, cause an apparatus to at least to perform: receiving, at a local site, one or more perspective video-plus-depth streams from one or more remote sites, the video-plus-depth streams comprising video data and corresponding depth data from a viewpoint of a user at the local site; decoding the one or more perspective video-plus-depth streams; receiving a unified virtual geometry determining at least positions of participants at the local site and the one or more remote sites; forming a combined panorama based on the decoded one or more perspective video-plus-depth streams and the unified virtual geometry; and forming a plurality of focal planes based on the combined panorama and the depth data.

According to a sixth aspect, there is provided an optionally non-transitory computer readable medium comprising program instructions that, when executed by at least one processor, cause an apparatus to at least to perform: capturing a plurality of video-plus-depth streams from different viewpoints towards a user at a local site, the video-plus-depth streams comprising video data and corresponding depth data; receiving a unified virtual geometry determining at least positions of participants at the local site and one or more remote sites; forming, in response to a request received from the one or more remote site, perspective video-plus-depth streams from a viewpoint of a user of the one or more remote site based on the captured video-plus-depth streams and the unified virtual geometry; and transmitting the perspective video-plus-depth streams to the one or more remote sites and/or to a server; or forming a multi-view-plus-depth stream based on the perspective video-plus-depth streams and transmitting the multi-view-plus-depth stream to a server.

According to an embodiment, the means comprises at least one processor; and at least one memory including computer program code, the at least one memory and the computer program code configured to, with the at least one processor, cause the performance of the apparatus.

According to a further aspect, there is provided a computer program configured to cause a method in accordance with the first aspect to be performed.

According to a further aspect, there is provided a computer program configured to cause a method in accordance with the second aspect to be performed.

### BRIEF DESCRIPTION OF THE DRAWINGS

FIG. 1 shows, by way of example, a telepresence system;

FIG. 2 illustrates, by way of example, the idea of bringing meeting sites into a common geometry;

FIG. 3a shows, by way of example, participants at different sites;

FIG. 3b shows, by way of example, different sites in their virtual positions;

FIG. 3c shows, by way of example, planar focal planes rendered to wearable display;

FIG. 4 illustrates, by way of example, updating viewpoints by tracking a mobile user;

FIG. 5 shows, by way of example, a flow chart of a method for session management.

FIG. 6 shows, by way of example, a user-centered panorama view;

FIG. 7 shows, by way of example, a schematic illustration for a multifocal near-eye display;

FIG. 8 shows, by way of example, a unified depth map projected to a set of planar focal planes and view from a user viewpoint;

FIG. 9 shows, by way of example, a spatially faithful telepresence session including interactions with augmented objects;

FIG. 10 shows, by way of example, a receiver module;

FIG. 11 shows, by way of example, a flow chart of a method;

FIG. 12 shows, by way of example, a flow chart of a method;

FIG. 13 shows, by way of example, a server-based system;

FIG. 14 shows, by way of example, a sequence diagram; and

FIG. 15 shows, by way of example, a block diagram of an apparatus.

### DETAILED DESCRIPTION

Physical meetings support spatial orientations and interactions in 3D space, including gaze awareness between participants. These properties may be difficult to support by traditional videoconferencing systems, wherein views from the remote parties may be e.g. collected into a video mosaic on a two-dimensional (2D) display instead of being displayed in a three-dimensional (3D) view. Spatially faithful telepresence refers to telepresence solutions, which aim to support mutual awareness of positions and gaze directions between meeting participants.

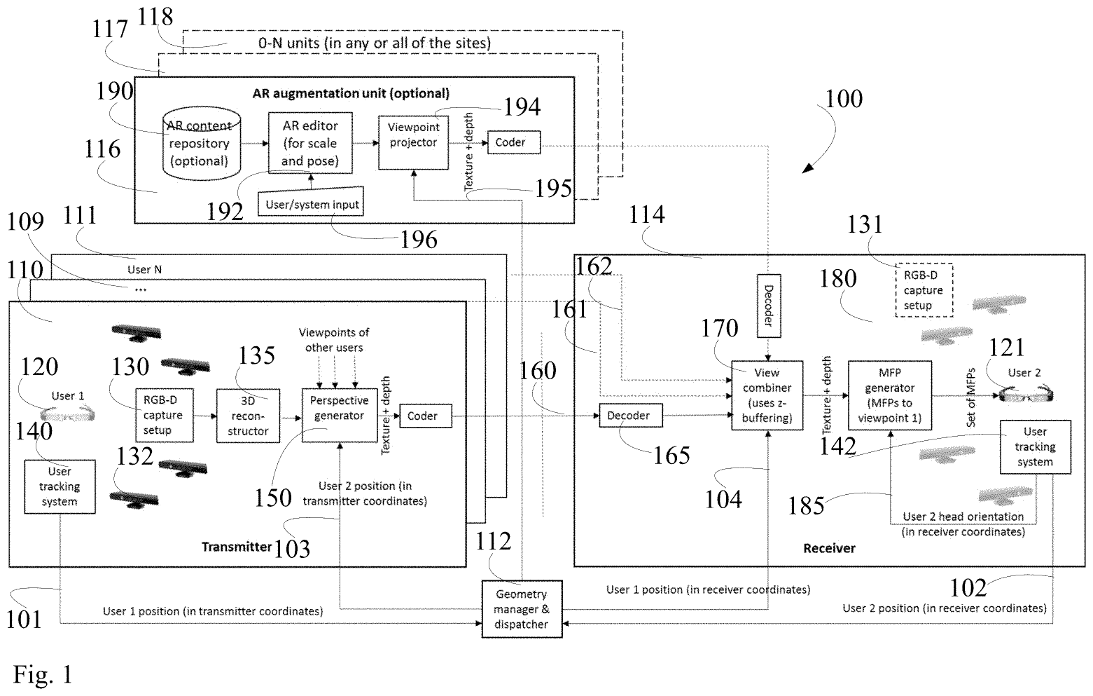

FIG. 1 shows, by way of example, a telepresence system 100. The system may comprise modules, such as one or more transmitter modules 110, server module 112, and a receiver module 114. In addition, the system may comprise one or more modules for supporting remote augmented reality (AR) augmentations, i.e. one or more AR modules 116, 117, 118. Data flow from multiple transmitters 109, 110, 111 to one receiver 114 is described, but the receiver acts also as a transmitter.

The system 100 enables natural telepresence between multiple sites and participants, and also interactions on AR objects, e.g. 3D objects. Users at transmitting site, or remote site, and at receiving site, or local site, may use wearable displays 120, 121, e.g. multifocal plane glasses display. For example, the users may wear optical see-through (OST) multifocal plane (MFP) near-eye-displays (NEDs). User at the receiving site may receive captured, e.g. on-demand captured, streams from transmitting site. The streams may comply with each user's viewpoint to other participants, and possibly objects such as AR objects. Meeting participants at transmitting site and the receiving site are captured in their natural environments using a capture setup. The capture setup may comprise e.g. camera(s) and other sensors. A consistent virtual meeting geometry, or layout or setup, may be formed for captured spaces and participants. The virtual meeting geometry may determine mutual orientations, distances, and viewpoints between participants. Users may be tracked to detect any changes of their positions and viewpoints.

Instead of sending complete 3D reconstructions to receiving terminals, perspective video-plus-depth streams may be formed, e.g. on-demand, based on tracked user positions. Video-plus-depth streams are a simpler data format when compared to complete 3D reconstructions. Simpler data format and/or on-demand user viewpoint capture support low bitrate transmission, and enable supporting natural occlusions and eye accommodation. Video-plus-depth streams may be coded and transmitted to receiving terminals. The streams may be merged at receiving terminals into one combined panorama view for viewing participants. When combining the separate streams, the received depth maps and textures may be processed, e.g. using z-buffering and z-ordering, to support natural occlusions between various scene components. The combined panorama, in video-plus-depth format, may be used to form multifocal planes (MFPs). The MFPs may be displayed for each viewing participant. The MFPs may be displayed e.g. by accommodative augmented reality/virtual reality (AR/VR) glasses, e.g. MFP glasses. The focal planes may show content naturally occluded.

The transmitter module 110 comprises a capture setup 130. As mentioned above, the receiver acts also a transmitter, and thus the receiver module 114 comprises a capture setup 131. Various approaches exist for performing 3D data capture and reconstruction. Geometric shape may be recovered by dense feature extraction and matching from captured images. In 3D telepresence systems, there may be multiple cameras at each meeting space to provide these images. Neural networks may be used to learn 3D shapes from multiple images. Depth sensors may be used to recover 3D shape(s) of the view. 3D data may be fused from multiple depth images e.g. through iterative closest point (ICP) algorithms. Neural networks may also be used to derive 3D shape from multiple depth views.

A capture front-end may capture 3D data from each user space, and form a projection towards each of the remote users in video-plus-depth format. 3D capture may be performed e.g. using a depth camera setup, e.g. with RGB-D sensors such as a Kinect V2 sensor 132, or the capture may be based on using conventional optical cameras, or a light-field capture setup. 3D reconstructions of the user space may be formed by any suitable way, e.g. by a 3D reconstructor 135, based on captured 3D data.

Several coordinate systems may be applied for describing captured data and 3D reconstructions. When using a Kinect V2 sensor, for example, camera coordinates may be used, which express captured data in a 3D coordinate system, where the origin (x=0, y=0) is located in the middle of the Kinect infrared (IR) sensor. X grows to the left from the sensor's point-of-view, y grows up, and z grows to the direction the sensor is facing. In the camera space, the coordinates may be measured in meters.

The transmitter module 110 comprises a user tracking system 140. The receiver module 114 comprises a user tracking system 142. A user position may be derived in various ways. For example, it may be expressed as a 3D point in the capture setup's coordinate system, e.g. the one described above for the Kinect. User position is thus an extra 3D position (three coordinate values) in addition to the captured camera/sensor data.

A Kinect sensor may express the data relative to the horizon, which is measured by the inertial position sensor, e.g. inertial measurement unit (IMU), of the Kinect. As a result, all captured spaces are having their floor levels parallel, and in case the sensor height is defined or known, the floor levels are even aligned. The latter is naturally favorable when combining remote views into a unified panorama in a receiving terminal. To support this alignment, a geometry manager comprised in the server module 112 may additionally receive for example the elevation of each 3D reconstruction from the floor level. Multiple 3D capture devices, e.g. Kinects, may be required for 3D reconstruction. This enables obtaining high quality perspective projections without holes in the view. For example, filtering and in-painting approaches may be applied to achieve projections without holes.

Supporting user mobility requires tracking of user positions in order to provide them with views from varying viewpoints. Tracking may be based, for example, on using a camera on each terminal, e.g. embedded into a near-eye display. Tracking may also be made from outside a user by external cameras. Visual tracking may enable achieving good enough accuracy for forming seamless augmented views, but using sensor fusion, e.g. IMUs or other electronic sensors, may be beneficial for increasing tracking speed, accuracy, and stability.

User tracking may comprise capturing a participant's facial orientation, as only part of received information may be visible at a time in a user's field of view in the glasses. The information on participant's facial orientation may be derived and used locally, and might not be used by other sites or parties. In addition to visual tracking, electronic sensors may be used to increase the accuracy and speed of head tracking. Head orientation information may be used to crop focal planes before rendering to MFP glasses. Head orientation comprises also possible head tilt. Thus, the focal planes may be cropped correctly also for head tilt.

The transmitter module 110 comprises a perspective generator 150. By tracking users in their meeting spaces, and mapping them into a unified geometry, user viewpoints and viewing distances are all the time known by the system. Perspective generator may receive the unified geometry from the server module 112. Perspective generator is used to form 2D projections of a local 3D reconstruction, and augmented 3D components, in case they have been added, to the viewpoint of each remote participant.

As a projection may be to any direction, virtual viewpoints may be supported. Viewpoint generation is challenged by sampling density in 3D data capture, and distortions generated by disocclusions, i.e. holes. Various means exist for mitigating these challenges, for example various filtering and in-painting approaches. The formed perspectives may be e.g. in video-plus-depth format, or a multi-view plus depth (MVD) format.

The server module 112 may comprise a geometry manager and a dispatcher. The server module may form a unified virtual geometry for a meeting session. The server module may receive the position of each user in their local coordinates, as described by arrows 101, 102. The server module may position the users and their meeting spaces in an appropriate orientation regarding each other, and may map the positions of all remote participants to each local coordinate system and may deliver this information to each local terminal, as described by arrows 103, 104. As a result, positions of all remote participants are known at each local/client terminal. Thus, the perspective generator 150 is able to form perspective views to the local 3D reconstruction from each remote viewpoint. The unified virtual geometry enables supporting spatial faithfulness. As an alternative to a separate server acting as a geometry manager, any of the participants, e.g. peers in a peer-to-peer implementation, may be assigned as a geometry manager.

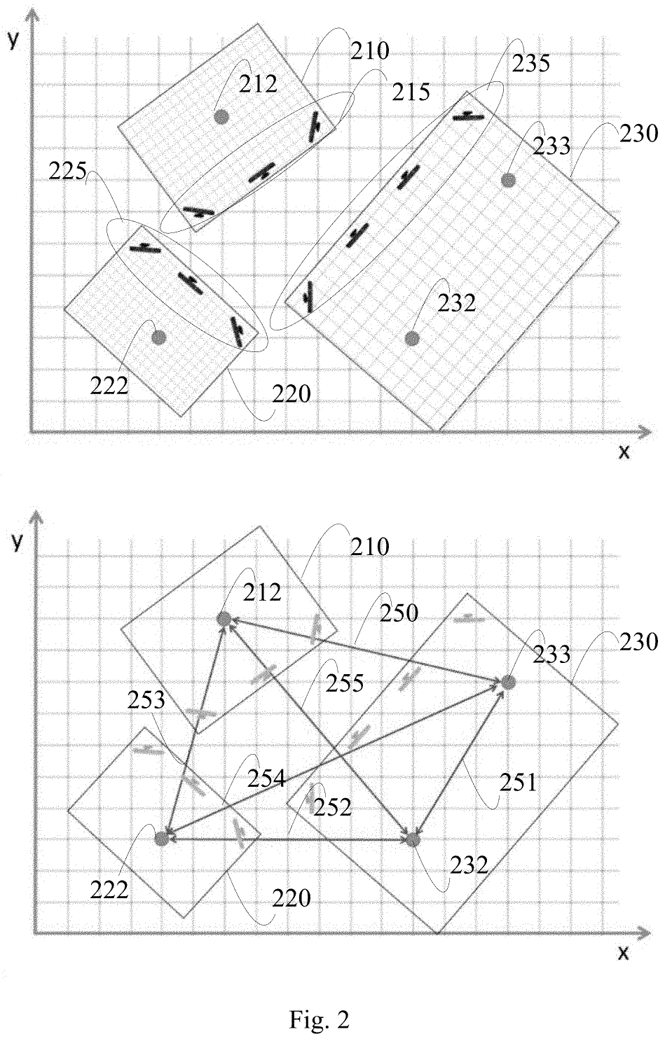

FIG. 2 illustrates, by way of example, the idea of bringing meeting sites into a common geometry. In the example, the three separate meeting spaces 210, 220, 230 with their users 212, 222, 232, 233 are captured with a capture setup 215, 225, 235 installed at the meeting spaces. The sites may be captured e.g. by RGB-D cameras in local coordinates. In FIG. 2, the principle of unifying geometries and deriving lines-of-sight is illustrated in 2D. However, the same approach applies also for meeting spaces captured in 3D. Each capture setup may capture 3D data in their own coordinates, with a known scale relating to the real world.

There may be a plurality of users in the same space, e.g. the user 232 and the user 233 in the space 230. The users may wear their own wearable displays.

A virtual meeting layout may be formed by placing captured meeting spaces in a spatial relation. The captured spaces may be mapped to a common coordinate system, e.g., one relative to the real world, by a cascaded matrix operation performing rotation, scaling, and translation. In particular, any user position in a captured sub-space, e.g. space 210, 220, 230 can be mapped to the coordinates of any other sub-space. Correspondingly, all viewpoints and viewing directions between participants are known, as indicated by arrows 250, 251, 252, 253, 254, 255 representing lines-of-sight in a global coordinate system between the users.

Spaces without a known scale may be brought into a common virtual geometry as well, but perceived distances and object sizes might not generally comply with those in the physical world. 3D sensors produce 3D reconstructions close to the real-world scale, possibly with various distortions due to inaccuracies e.g. in capture, calibration and mapping. Whatever coordinates are used for captures, 3D reconstructions may also be scaled intentionally for generating special effects, i.e. compromising reality, in rendering. When using 3D sensors and 3D reconstruction, each viewpoint may be supported without a physical camera in the viewing point. Hybrid approaches using both cameras and 3D sensors may also be used.

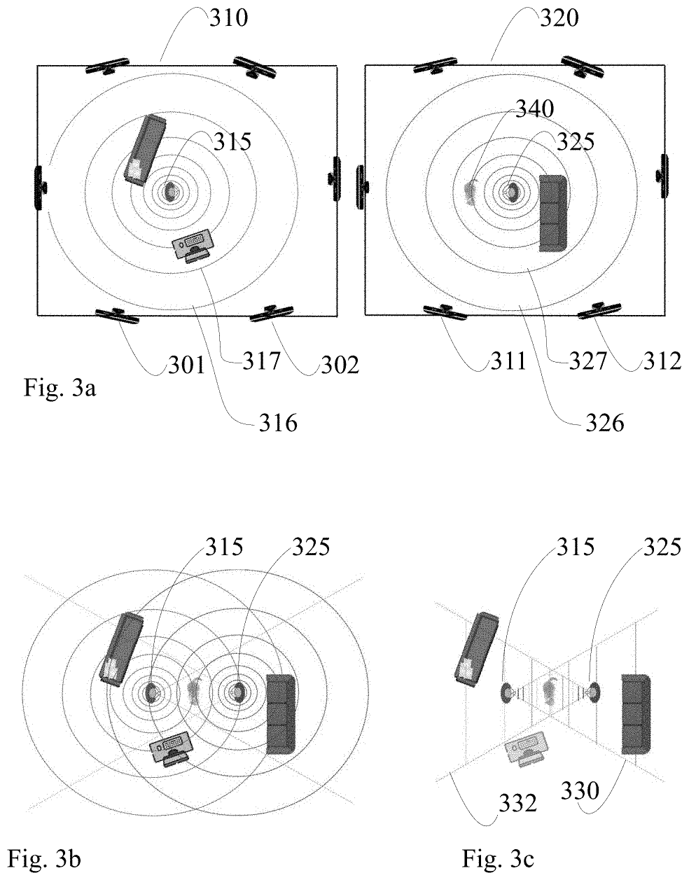

FIG. 3a shows, by way of example, participants at different sites, e.g. at a first site 310 and a second site 320, captured by depth sensors 301, 302, 311, 312 positioned around the users at both sites. For simplicity, identical rooms and capture setups are shown. Capture setups may, however, be different from each other. FIG. 3a illustrates perceiving depth in a spatially faithful telepresence session between two parties. Participants 315, 325 are captured in their physical environment by a setup of depth sensors 301, 302 at the first site 310, and a setup of depth sensors 311, 312 at the second site 320. The participants perceive their spaces as co-centric focal planes, or spheres, due to human eye structure. A users' perception for depth is illustrated by circles 316, 317, 326. 327, i.e. 360° panorama images around the user. A human eye comprises one lens system with a spherical sensor, i.e. a retina. Due to those properties of a human eye, fixed focal distances from each user's point of view form co-centric spheres or hyperplanes. Human visual system suggests further using focal distances at linear intervals on a dioptric scale, which means that focal hyperplanes are more densely near the eyes and get sparser along increasing distance from the user.

A unified geometry may be formed as described above. This means that the two meeting sites with their participants are taken into a common geometry, so that the spaces are virtually in close geometrical relation with each other. FIG. 3b illustrates the two spaces in their new virtual positions. Fixed focal distances with points in focus may again be illustrated as concentric spheres around the participants 315, 325. FIG. 3b shows the focal planes seen by eyes of the participants 315, 325 when their orientations are towards each other.

FIG. 3c shows, bay way of example, the planar focal planes rendered to wearable display, e.g. to glasses-based display. Eyes are able to view sideways within a filed-of-view to the combined scene. A first field-of-view 330 is the field-of-view of the participant 315 at the first site. A second field-of-view 332 is the field-of-view of the participant 325 at the second site. 3D reconstructions based on captured depth information may be used to form stacks of focal planes from each user's viewpoint, e.g. at regular distances in dioptric scale, increasing intervals in linear scale. Due to planar sensors used typically in visual cameras and depth sensors, the planar focal planes may typically be formed. Forming full panoramas might not be necessary, as at each time a limited solid angle or field-of-view is anyway visible for a viewer. However, panoramas may be used if seen beneficial for computational or latency reasons, e.g. for speeding up responses to changing viewing directions.

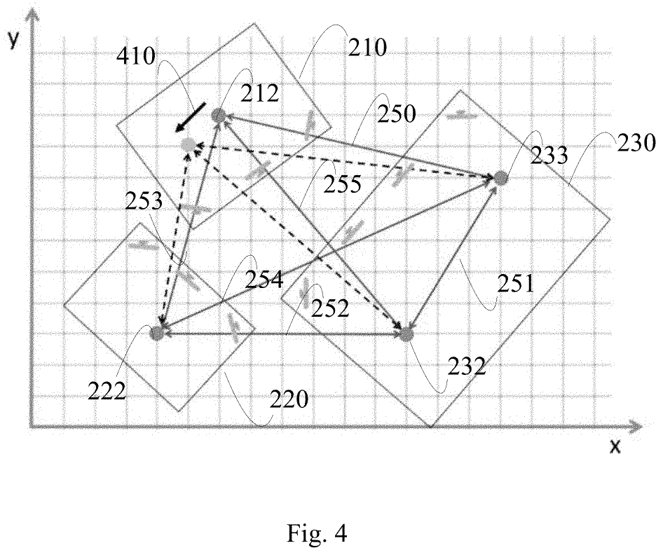

After a virtual geometry is defined between participants and sites, the geometry may be fixed. Users may change position, and therefore, the mobile users may be tracked by the user tracking system to enable updating viewpoints. Thus, viewer's motions may be detected and tracked in order to produce a correct new view to the viewer. FIG. 4 illustrates, by way of example, updating viewpoints by tracking a mobile user 212 who has changed 410 its position.

When using near-eye displays for viewing, and AR paradigm to render remote participants, motion detection and tracking may be based on those used in AR applications. In AR, detecting of a user's viewpoint is important in order to show augmented objects in correct positions in the environment. For example, graphical markers in the environment may be used to ease up binding virtual objects into the scene. Alternatively, natural features in the environment may be detected for this purpose.

In a glasses-based telepresence, remote participants may be augmented in a user's view. In order to render participants in correct positions, each user's viewpoint needs to be known. When using glasses-based displays, a camera and other glass-embedded sensors may be used to track a viewer's position and viewing direction. In addition to or alternatively to camera based methods, depth sensors, e.g. time-of-flight (ToF) cameras, and motion sensors, e.g. IMUs, may be used for AR tracking.

Participants' environments may be both sampled and rendered as planar focal planes (MPs). Constructing a scene from planar focal planes does not conflict with accommodating to the result spherically: perception as such is independent of the sampling and rendering structure, although the latter naturally affects to the average error distribution and quality of the scene. However, quality is primarily determined by the sampling structure and density, e.g. the focal plane structure and density, and the used means for interpolating between samples, e.g. depth blending between planar MFPs.

In order to support natural occlusions in a spatially faithful geometry, both remote and local spaces may be captured from each user's viewpoint. A foreground object, e.g. a cat 340 at the second site 320 in FIG. 3a, makes a hole in any virtual or captured data further away from the user, e.g. from the participant 325 at the second site 320, in the virtual setup. Foreground occlusion will be described later in more detail.

In order for a local person to see remote participants, their captures may be positioned closer than a remote wall of a local space. This may be ensured when defining the unified meeting geometry. Another option is to use 3D analysis and processing to remove obstructing walls from 3D captures.

To summarize, in order to unify captured user spaces into a virtual meeting setup geometry combiner needs 3D data in each local coordinate system, together with their scale. If 3D sensors are used, the scale is inherently that of the real world. Geometry combiner maps each local capture into one 3D meeting setup/volume, e.g. by a matrix operation. This data includes also positions of the users, tracked and expressed in their local coordinates. After the mapping, the server can express each user position, i.e. viewpoints, in any local coordinates. Each remote viewpoint is delivered to each of the local spaces, where each transmitter forms corresponding 3D projections of the local 3D reconstruction towards each remote viewpoint. This data is obtained and transmitted primarily in video plus depth format.

The system 100 may use peer-to-peer (P2P), i.e. full mesh, connections between meeting spaces. In a P2P approach, a server is not required or used for the transmission of visual and depth data. Instead, a transmitter in each node, i.e. at each site, sends each user perspective as an own video-plus-depth stream to all other users at other sites. However, in a server based embodiment, a centralized server module may deliver all viewpoint streams between participants.

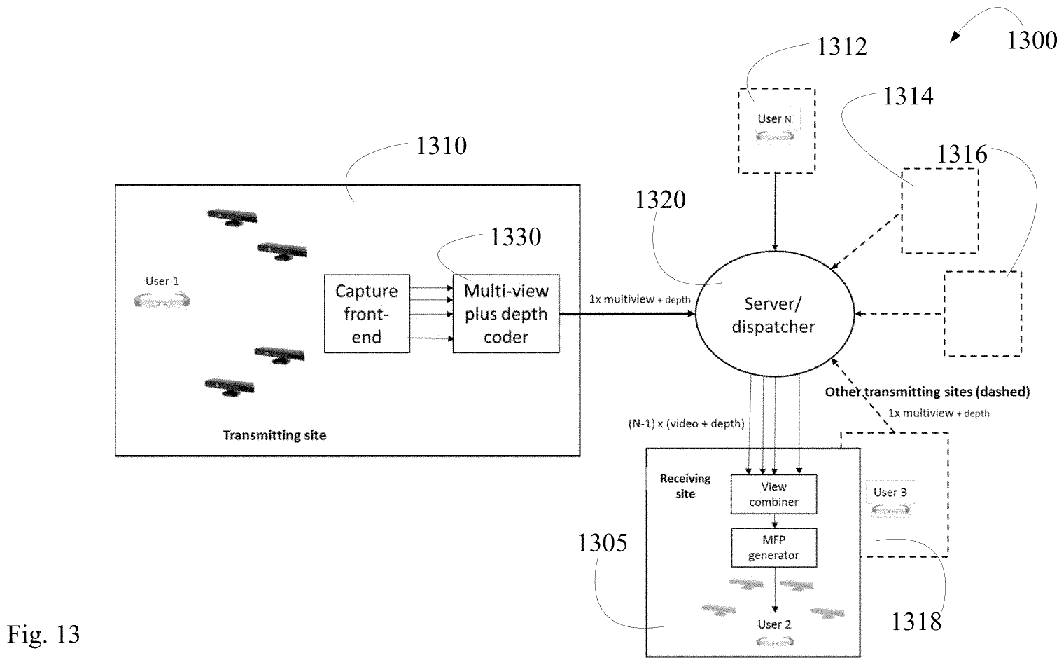

The data delivery in P2P and server based solutions may differ regarding the applicable or optimum coding methods, and corresponding produced bitrates. In the server based variation, before uplink transmission to the server, separate video plus depth streams may for example be combined, at the transmitting site, into one multi-view-plus-depth stream for improved coding efficiency. This will be described later in the context of FIG. 13.

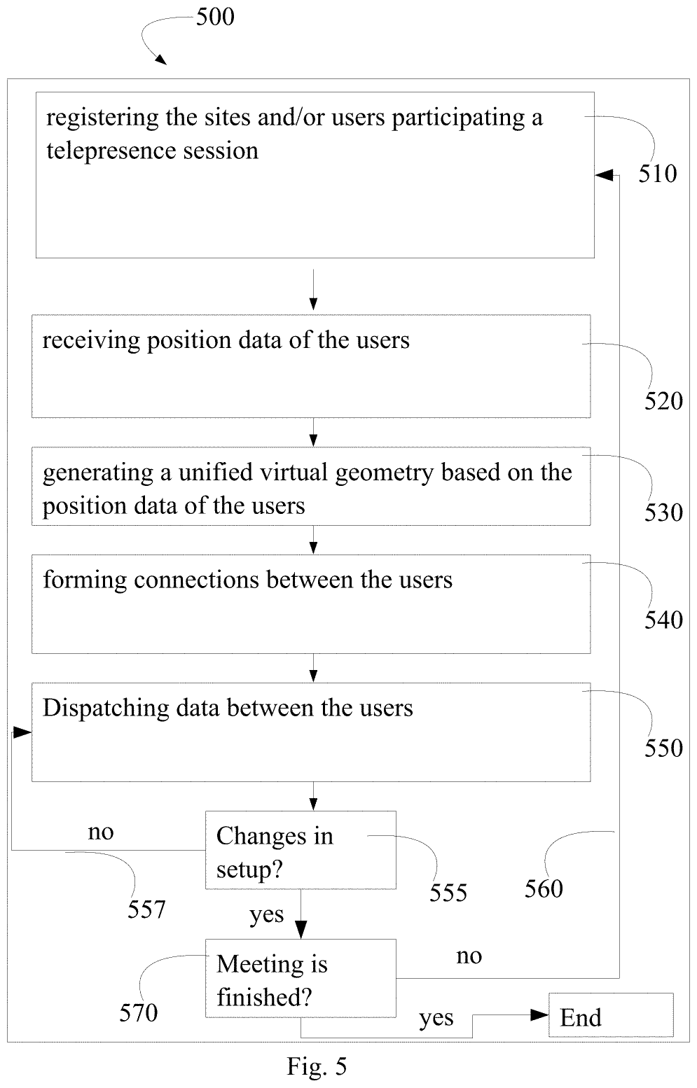

A server module 112 of a spatially faithful telepresence system may make session management to start, run, and end a session between involved participants. FIG. 5 shows, by way of example, a flow chart of a method 500 for session management. The method 500 comprises registering 510 the sites, and/or users, participating a telepresence session. The method 500 comprises receiving 520 position data of the users. The method 500 comprises generating 530 a unified virtual geometry based on the position data of the users. The common virtual geometry is generated between all sites and users. The method 500 comprises forming 540 connections between the users. The method 500 comprises dispatching 550 data, e.g. video data, depth data, audio data, position data, between the users, or between the peers. The method comprises, in response to detecting 555 changes in setup, re-registering 560 the sites and/or users participating a telepresence session, and repeating the steps of the method 500. Changes in setup may comprise e.g. changes in positions of the users, which causes changes to the unified virtual geometry. Changes in setup may comprise changes in number of participants. For example, user(s) may quit the session, or user(s) may join the session, which causes changes to the unified virtual geometry. In case there are no changes in setup 557, the server module may keep dispatching data, e.g. video data, depth data and audio data, between the users.

Users may indicate by user input that the meeting is finished 570, and then the server module may end the session.

The system 100 may support capture and delivery of audio signals, e.g. spatial audio signals.

Referring back to FIG. 1, the receiver module 114 represents the viewing participant at each receiving site, or local site. Remote captures may be combined to a combined representation. The receiver module may receive 160, 161, 162 user views to each remote site in video-plus-depth format. The video-plus-depth stream comprises video data and corresponding depth data. The streams may be received from a remote site over P2P or server connections. The video-plus-depth stream is a real-time sequence of textured 3D surfaces. Each pixel of the view is associated by its distance in the view. This stream format is beneficial for supporting natural occlusions and accommodations.

The perspective video-plus-depth streams may be decoded by one or more decoders 165.

The receiver module 114 may receive a unified virtual geometry from the server module 112 comprising the geometry manager. The unified virtual geometry may determine at least positions of participants at the local site and the one or more remote sites. The consistent virtual meeting geometry, or layout or setup, may determine mutual orientations, distances and viewpoints between participants. In case the users move, i.e. change position, the geometry may be updated by the geometry manager in response to received tracked user positions. Then, the receiver module may receive an updated unified virtual geometry.

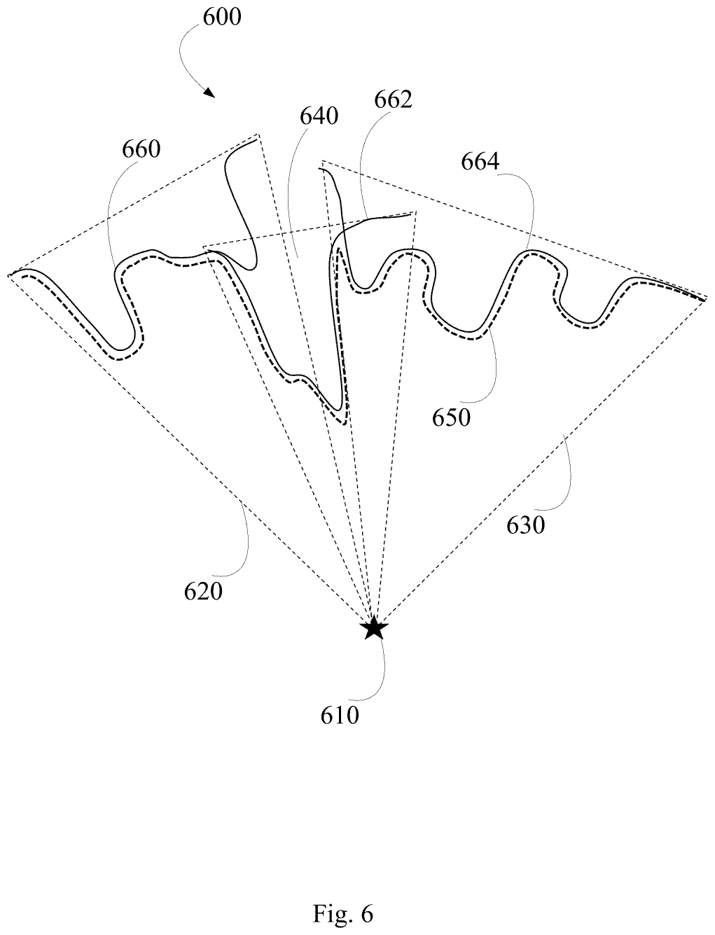

The receiver module 114 may comprise a view combiner 170. The receiver module may form a combined panorama based on the decoded perspective video-plus-depth streams and the unified virtual geometry. Forming the combined panorama may comprise z-buffering the depth data and z-ordering the video data. The view combiner may comprise an occlusion manager. Occlusions may be supported by z-buffering the received depth maps, and z-ordering video textures correspondingly. Z-buffering and z-ordering may result one combined video-plus-depth representation, with correct occlusions. The received views have been formed, on-demand, from the receiving user's viewpoint. The view combiner 170 may compile the separate views, i.e. frustums, into a unified panorama. The directions of the frustums may be determined by the defined geometry, i.e. lines-of-sight, between participants. Z-buffering uses the separate depth views, i.e. depth maps, to determine the order in depth, i.e. the z-order, for each view component. As a result, textures of the closer objects occlude those more far away. Z-buffering produces a unified depth map for the combined panorama view. FIG. 6 shows, by way of example, a user-centered panorama view 600, i.e. a view from a user viewpoint 610. FIG. 6 shows frustum 620 to site X and a frustum 630 to site Y. Further, FIG. 6 shows a frustum 640, exemplary to an AR object. The dashed line 650 represents the combined depth map formed by z-buffering. Lines 660, 662, 664 represent the individual depth maps of sites X, AR object, and site Y, respectively.

When rendering virtual or remotely captured, natural, information on local viewer's display, content and objects at various levels of depth are combined. Although the content is not real in the sense that it combines data from various spaces, it is important to comply with real-world occlusions in order to support naturalness and realism of the views. Occlusions are the result of object distances in depth. Objects more close should occlude those more far away to support naturalness.

Occlusions may be supported also partly. So-called background occlusion means that a virtual object is able to occlude natural background. Occlusions require non-transparency, which in OST AR glasses means that a background view or background information may be blocked and replaced by more close, virtual or captured, objects.

Foreground occlusion means that natural objects, for example a person passing close by, should occlude any virtual information rendered more far in the view. For example, in OST AR glasses, real-time segmentation of the physical view by its depth properties is required. Image processing means for supporting foreground occlusions may thus be different from those supporting background occlusions. Background and foreground occlusions together are referred to as mutual occlusions. Naturalness of occlusions may require support of mutual occlusions.

Instead of showing the augmented objects as ghost like transparencies e.g. on the glasses-based display, the system disclosed herein support natural occlusions.

After z-buffering all scene components, the result is a combined depth map, e.g. the depth map 650 in FIG. 6, and a so called z-ordered texture image towards each viewpoint, i.e. towards each participant. In the combined depth map, any closer object occludes all further away objects in a natural way, irrespective of whether the objects are virtual or captured from the local or remote sites.

The receiver module 114 may comprise an MFP generator 180. The receiver module 114 may form, e.g. by the MFP generator, a plurality of focal planes based on the combined panorama and the depth data. Focal planes are formed in order to support natural accommodation to the view. Each user view is a perspective projection to a 3D composition of the whole meeting setup, formed by z-buffering and z-ordering. In addition to pixel colors in the view, their distances are known, and normal depth blending approaches may be used for forming any chosen number of focal planes.

In a real-world space, human eyes are able to scan freely and to pick information by focusing and accommodating to different distances, i.e. depths. When viewing, the (con)vergence of the eyes varies between seeing to parallel directions, e.g. seeing the objects at the infinity, and seeing to very crossed directions, e.g. seeing the objects close to the eyes. Convergence and accommodation are strongly coupled, so that most of the time, the accommodation points, i.e. the focal points, and the convergence point of the two eyes meet at the same 3D point. In conventional stereoscopic viewing, the eyes are focused on the same image/display plane, while the human visual system (HVS) and the brain form the 3D perception by detecting the so called disparity of the images, i.e. the small distances of corresponding pixels in the two 2D projections. In stereoscopic viewing, vergence and accommodation points may be different, which may cause so called vergence-accommodation conflict (VAC). VAC may cause visual strain and other types of discomfort, e.g. for users of near eye displays (NEDs). Multifocal planes (MFPs) may be used to support accommodation.

MFP displays create a stack of discrete focal planes, composing a 3D scene from layers along a viewer's visual axis. A view to the 3D scene is formed by projecting to the user all those pixels, or more precisely voxels, which are visible at different depths and spatial angles. Each focal plane samples the 3-D view, or projections of the 3D view, within a depth range around the position of the focal plane. Depth blending is a method used to smooth out the otherwise many times perceived quantization steps and contouring when seeing views compiled from discrete focal planes. With depth blending, the number of the focal planes may be reduced, e.g. down to around five without degrading the quality too much.

Due to the properties of a human visual system (HVS), more optimal result may be achieved when placing focal planes linearly on a dioptric scale. This means that focal planes are densely near the eye, and separate by increasing distance.

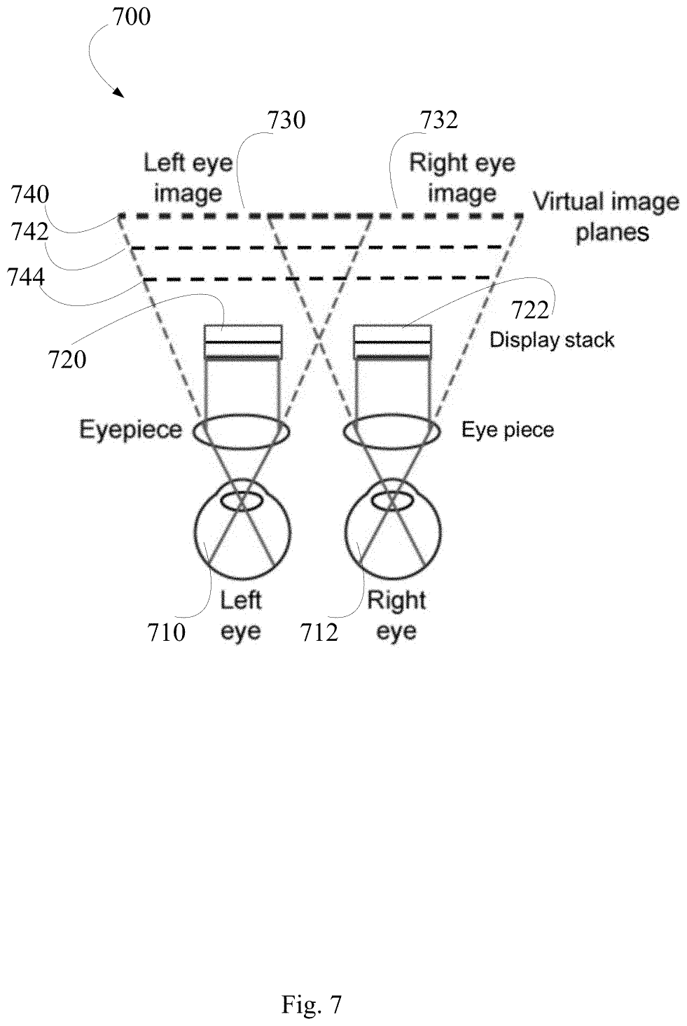

Multifocal display may be implemented either by spatially multiplexing a stack of 2-D displays, or by sequentially switching in a time-multiplexed way the focal distance of a single 2-D display by a high-speed birefringent, or by a varifocal element, while spatially rendering the visible parts of corresponding multifocal image frames. FIG. 7 shows a schematic illustration 700 for a multifocal near-eye display (NED). Display stacks 720, 722 are shown for the left eye 710 and the right eye 712, respectively. The contents (focal planes) of the display stacks are from stereoscopic viewpoints, i.e. the display stacks show two sets of focal planes. The two sets of focal planes may be supported by using the described viewpoint and focal plane formation for each eye separately, or e.g. after first forming one set of focal planes 740, 742, 744, e.g. from an average viewpoint of a viewer, i.e. between user's eyes. Amount of disparity and orientation of the baseline may be varied flexibly, thus serving e.g. head tilt and motion parallax. Left eye image 730 is in the field-of-view of the left eye, and the right eye image 732 is in the field-of-view of the right eye. Virtual image planes 740, 742, 744 correspond to the multifocal planes. Multifocal plane (MFP) displays create an approximation for the light-field of the displayed scene. Due to a near-eye display's movement along with a user's head movements, one viewpoint needs to be supported at a time. Correspondingly, the approximation for the light field is easier, as capturing a more complete light-field for large number of viewpoints is not needed.

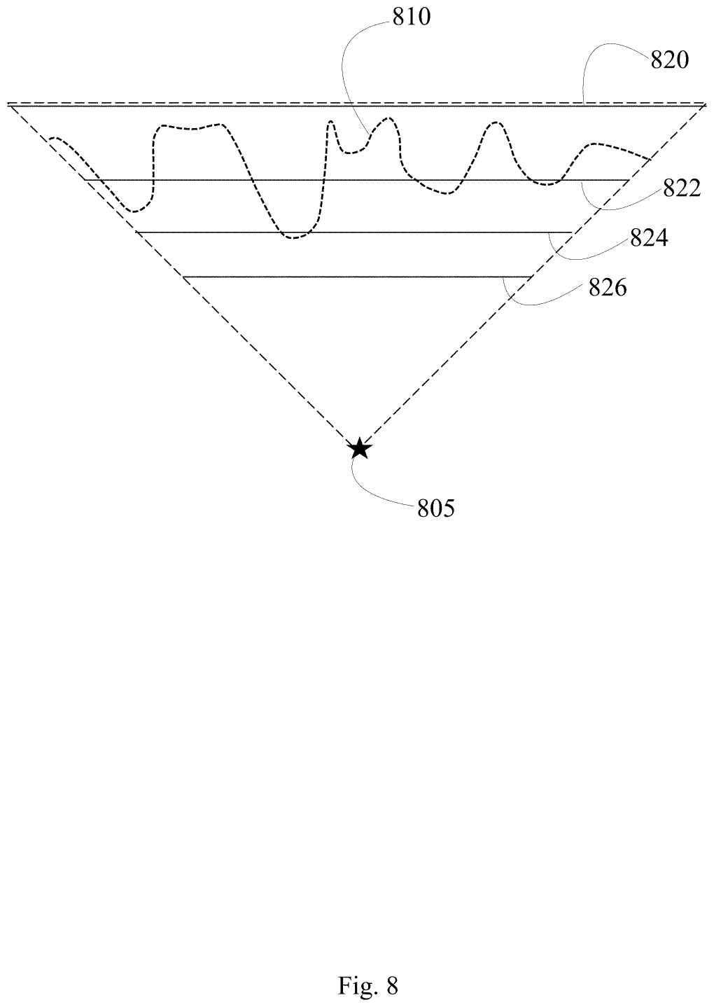

View combiner's output, a combined panorama and its depth map, may be used to form multifocal planes (MFPs). Focal planes are formed by decomposing a texture image into layers by using its depth map. Each layer is formed by weighting its nearby pixels, or more precisely voxels. Weighting, e.g. by depth blending or other feasible method, may be performed to reduce the number of planes required for achieving a certain quality. FIG. 8 shows, by way of example, a unified depth map, or a combined depth map 810, projected to a set of planar focal planes 820, 822, 824, 826, and view from a user viewpoint 805. However, as shown in FIG. 6, the depth map is more precisely formed from several planar projections from multiple sectors around a viewpoint approaching a spherical shape with a large number of frustums. Choosing the projection geometry might not be particularly critical due to the rather insensitive perception of depth by human visual system.

The receiver module 114 may render the plurality of focal planes for display. The MFPs may be displayed by wearable displays, e.g. by an MFP glasses display 121. It renders focal planes along a viewer's visual axis, and composes an approximation of the original 3D scene. When viewing focal planes with MFP glasses, natural accommodation, i.e. eye focus, is supported.

The MFPs may be wider than the field-of-view of the glasses display. The receiver module, or the MFP generator, may receive 185 head orientation data of a user at the local site. Head orientation information from the user tracking system 142 may be used to crop the focal planes before rendering them to the MFP glasses. As focal planes are formed independently in each receiving terminal, the approach is flexible for glasses with any number of MFPs.

Referring back to FIG. 6, the viewing frustums of each user comprises views to remote meeting sites, e.g. sites X and Y. In addition, the frustum may further comprise a physical object in the foreground, e.g. a colleague or family member passing by, and/or an AR object, e.g. a 3D object. The AR object, e.g. a 3D object, may be augmented into the combined view. Augmented objects, e.g. 3D objects or animations, may be positioned to the local and/or to the remote site, and/or to a virtual space, e.g. to a virtual space between the sites. The AR module 116 (FIG. 1) may comprise an AR content repository 190, e.g. a database storing AR content, e.g. 3D objects. The AR module may comprise an AR editor 192 for determining the scale and/or pose for the AR object. The AR editor may receive input 196 for positioning and/or scaling the augmented objects into the unified virtual geometry and view. Input may be received from the user, e.g. via manual input, or from the system in a (semi)automatic manner. The AR object may be projected, by the viewpoint projector 194, to each participant's viewpoint from its chosen position. Viewpoint projector receives 195 the unified virtual geometry from the server module 112. A texture-plus-depth representation, or one or more texture-plus-depth representations, of an AR object, or of one or more AR objects, may be produced which is comparable to video-plus-depth representation captured from the physical views at remote sites. As an alternative to still AR objects, the AR object may be an animation. Therefore, a plurality of texture-plus-depth representations of an AR object may comprise a video-plus-depth representation. The AR editor may be operated by a viewer at the local site or by a remote participant at any of the remote sites.

Texture-plus-depth representations of AR objects may be combined, by the view combiner 170, to the unified view by z-buffering in the way described above for the captured components. As a result, any close objects occlude those more far away parts of the scene.

AR objects may be brought to any position in the unified meeting geometry, i.e. to any of the participating sites, or space in between them. Defining positions of AR objects in a unified meeting geometry, and forming their projections and MFP representations are made in the same way as for human participants. For AR objects, however, data transfer is only uplink, i.e. non-symmetrical.

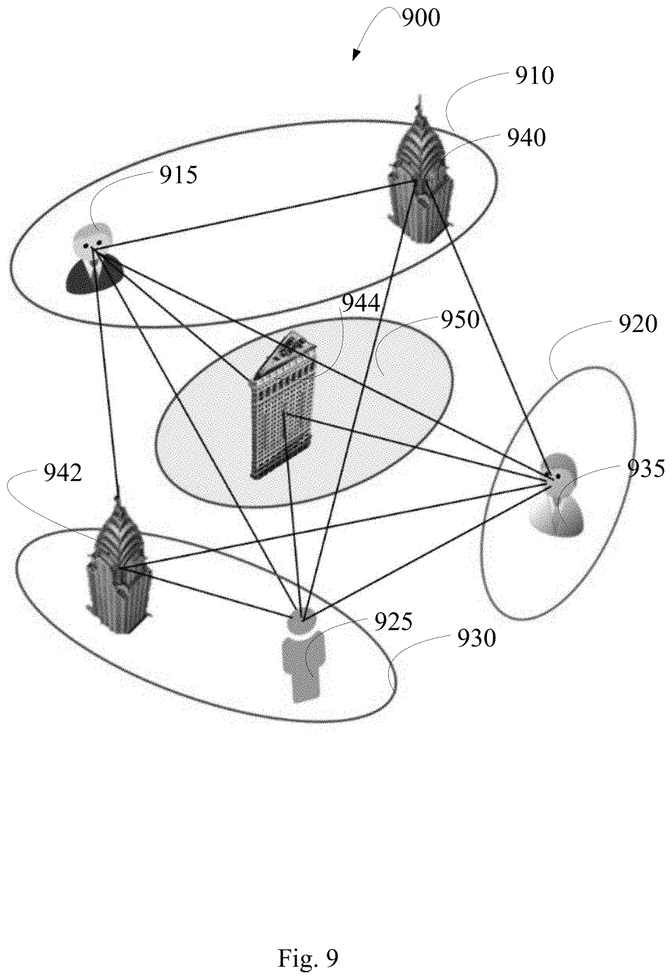

FIG. 9 shows, by way of example, a spatially faithful telepresence session 900 including interactions with augmented objects. Three participants 915, 925, 935 at three different sites 910, 920, 930 participate the session. AR objects, e.g. buildings 940, 942, 944, have been augmented inside two sites, and one in a virtual space 950 between the sites. Lines-of-sight are shown between the participants and towards the AR objects. Differing from foreground occlusion by physical objects, occluding by virtual objects does not require capturing local spaces from each viewer's viewpoint.

The capture setup in each participant's meeting space may further capture at least the depth data, or video-plus-depth data of foreground objects. The foreground objects may be taken as components in z-buffering. From a local participant's viewpoint, part of the local space is included in the unified virtual view. Physical objects entering or passing this view, e.g. family members, pets, colleagues, etc. should occlude the views received from remote spaces. This may be referred to as foreground occlusion.

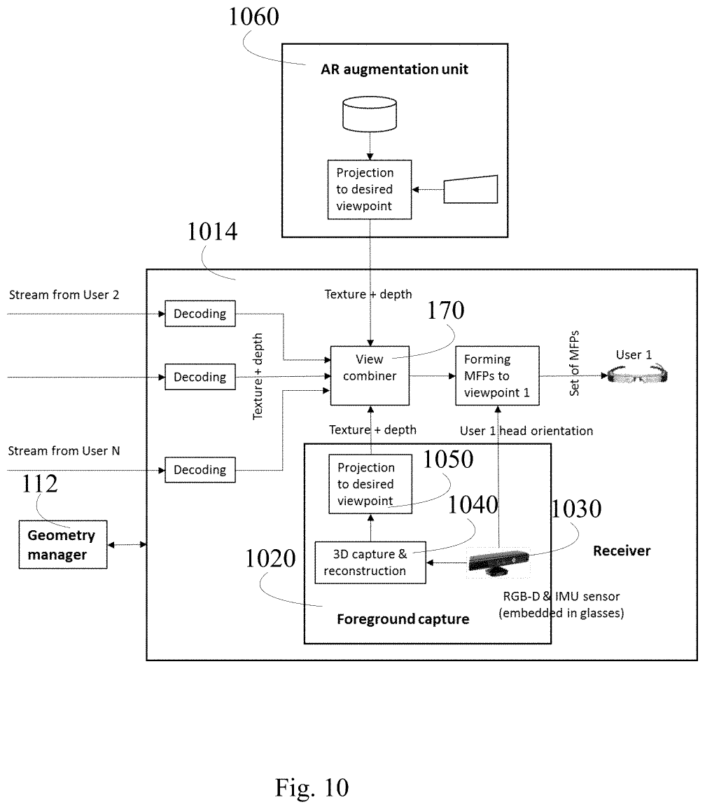

For foreground occlusion, the user space needs to be captured from the viewpoint of a local user. For natural occlusions to support both directions along a line-of-sight, the user space needs to be captured both towards a local user, and from the viewpoint of the same user. FIG. 10 shows, by way of example, a receiver module 1014. The receiver module may comprise a foreground capture 1020 module for capturing foreground objects at the local site. 3D capture and reconstruction 1040 may be performed for the foreground objects. Capturing depth data may be enough for foreground objects, as described below. The participants may be assumed to wear glasses type of wearable displays comprising capture sensors, e.g. RGB-D sensors 1030, attached to the structure of the glasses. Alternatively to glasses embedded sensor, capture sensor(s) for foreground occlusion may be aside the participant and the viewpoint virtually formed from the viewpoint of the user. IMU sensor(s), e.g. embedded in the glasses, may be used for head tracking, and head orientation determination. Support for full user mobility, e.g. 6 degrees of freedom (DoF), may be provided by the glasses.

The foreground object may be projected 1050 to the viewer's viewpoint.

The view combiner 170 may receive the video-plus-depth data of the foreground object, and incorporate that to the combined panorama. The view combiner may receive the video-plus-depth data of the AR objects, from the AR module 1060. The AR module 1060 is shown as a local entity in the receiver in FIG. 10. Therefore, coding and decoding might not be needed for AR objects.

For optical see-through glasses, foreground occlusion may be made so that a local occluding object makes a hole to any virtual information further away. For example, the depth map of the local object may be taken into the earlier described z-buffering, for finding the depth order of the scene components. As physical objects are seen through the OST glasses structure, it might not be necessary to capture or display their texture, but instead, to make a hole to any virtual information on the object area. Thus, foreground capture may comprise depth data capture without video capture.

The focal planes may be used to support virtual viewpoint formation for stereoscopy. Further, focal planes may be used to form virtual viewpoints for motion parallax, without receiving any new data over network. This property may be used to reduce latencies in transmission, or reduce data received for new viewpoints over network. Information on user motions may be received for supporting this functionality.

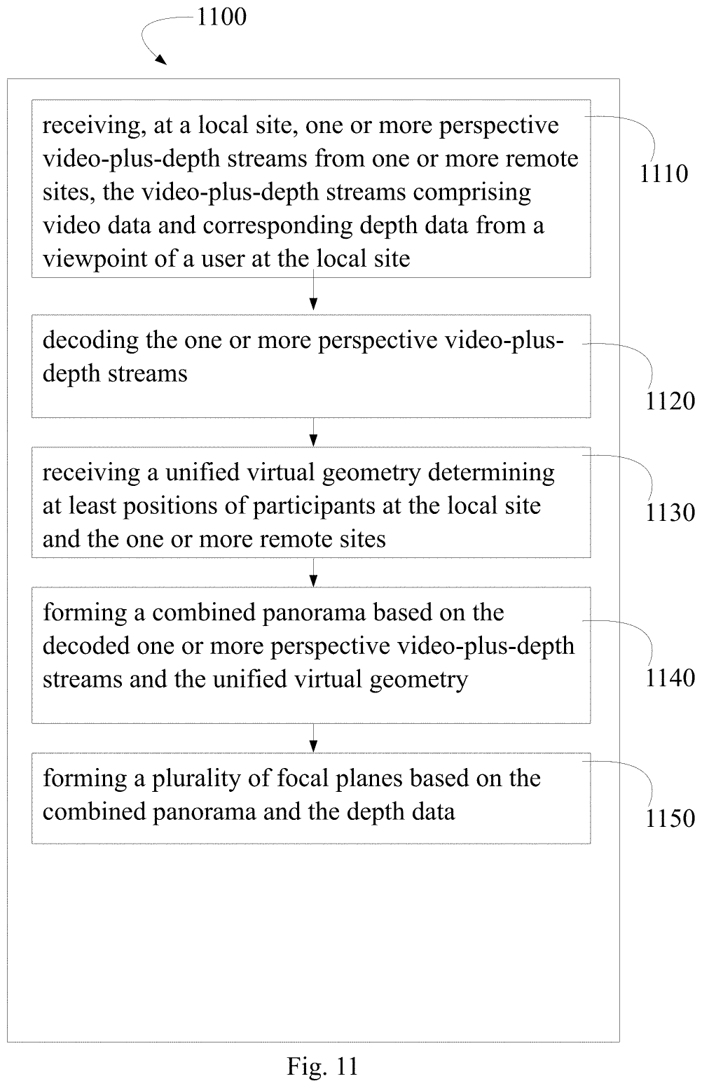

FIG. 11 shows, by way of example, a flow chart of a method 1100. The phases of the illustrated method may be performed at the receiver module. The method may be performed e.g. in an apparatus 114. The method 1100 comprises receiving 1110, at a local site, one or more perspective video-plus-depth streams from one or more remote sites, the video-plus-depth streams comprising video data and corresponding depth data from a viewpoint of a user at the local site. The method 1100 comprises decoding 1120 the one or more perspective video-plus-depth streams. The method 1100 comprises receiving 1130 a unified virtual geometry determining at least positions of participants at the local site and the one or more remote sites. The method 1100 comprises forming 1130 a combined panorama based on the decoded one or more perspective video-plus-depth streams and the unified virtual geometry. The method 1100 comprises forming 1150 a plurality of focal planes based on the combined panorama and the depth data.

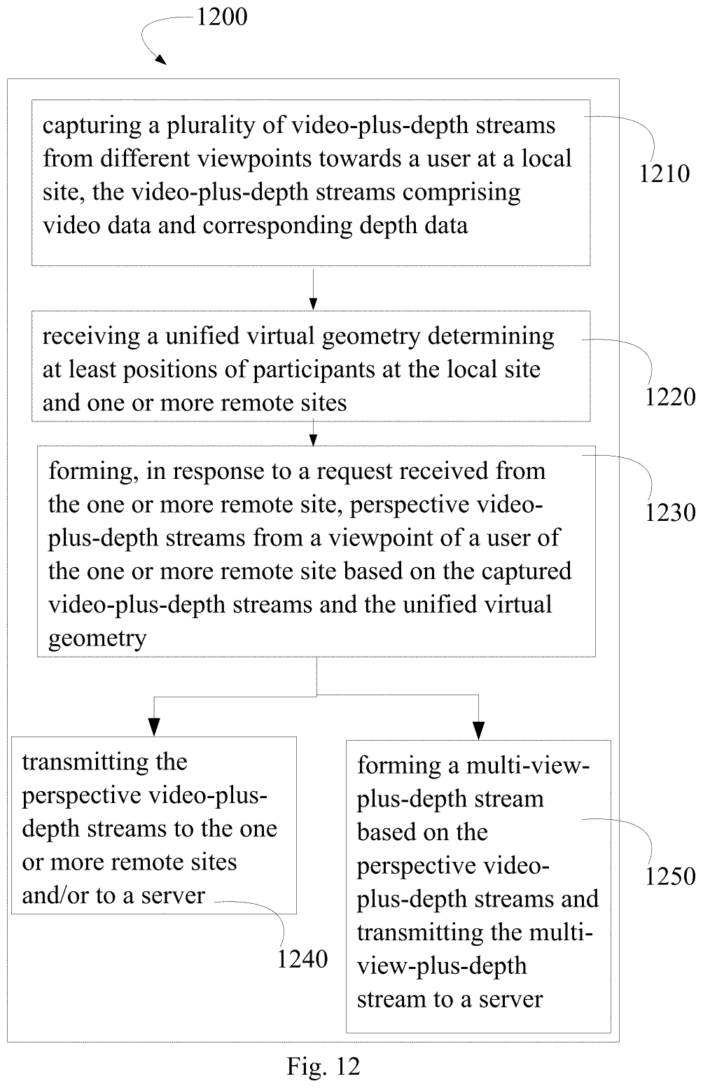

FIG. 12 shows, by way of example, a flow chart of a method 1200. The phases of the illustrated method may be performed at the transmitter module. The method may be performed e.g. in an apparatus 110. The method 1200 comprises capturing 1210 a plurality of video-plus-depth streams from different viewpoints towards a user at a local site, the video-plus-depth streams comprising video data and corresponding depth data. The method 1200 comprises receiving 1220 a unified virtual geometry determining at least positions of participants at the local site and one or more remote sites. The method 1200 comprises forming 1230, in response to a request received from the one or more remote site, perspective video-plus-depth streams from a viewpoint of a user of the one or more remote site based on the captured video-plus-depth streams and the unified virtual geometry. The method 1200 comprises transmitting 1240 the perspective video-plus-depth streams to the one or more remote sites and/or to a server; or forming 1250 a multi-view-plus-depth stream based on the perspective video-plus-depth streams and transmitting the multi-view-plus-depth stream to a server.

The method 1100 and the method 1200 may be performed by the same apparatus, since the receiver acts also as a transmitter.

FIG. 13 shows, by way of example, a server-based system 1300. For simplicity, data is shown to be received by one terminal, a receiving site 1305, but each receiver acts also as a transmitter, i.e. the system is symmetrical. In the server-based system, all video-plus-depth perspectives are first sent from a transmitting site 1310 to a server 1320 or a dispatcher, which dispatches a correct perspective to each of the counterparts. This approach enables coding of all viewpoints as one multi-view-plus-depth stream, e.g. by a multi-view-plus-depth coder 1330. The multi-view-plus-depth coder may user e.g. a multi-view high efficiency video coding method (MV-HEVC). Use of multi-view-plus-depth stream may be more efficient over sending user perspectives separately in a P2P network.

In P2P network, the transmitter may transmit (N−1) video-plus-depth streams to other participants, wherein N is the number of participants in the meeting. Correspondingly, the receiver may receive (N−1) video-plus-depth streams from other participants.

In the server-based system, the transmitter 1310, 1312, 1314, 1316, 1318 may transmit one multi-view-plus-depth stream to the server. Unlike in P2P network, in the server-based system, all viewpoints to remote sites, e.g. to the receiving site 1305, are received over a server connection, instead of separate P2P connections. As the viewpoints are primarily to different remote sub-spaces, the set of viewpoint streams do not particularly benefit from multi-view coding. The streams may thus be received at the receiving site as separate video-plus-depth streams from the server. In other words, the receiver may receiver (N−1) video-plus-depth streams also in the server-based system.

A further server-based solution may be provided, in which all sensor streams are uploaded to a server, which reconstructs all user spaces, projects them, and delivers to all remote users as video-plus-depth streams. This, however, may require higher bitrates and more computation power than the above-described server-based variation. However, even this option is less bitrate consuming than delivering all sensor streams to all users.

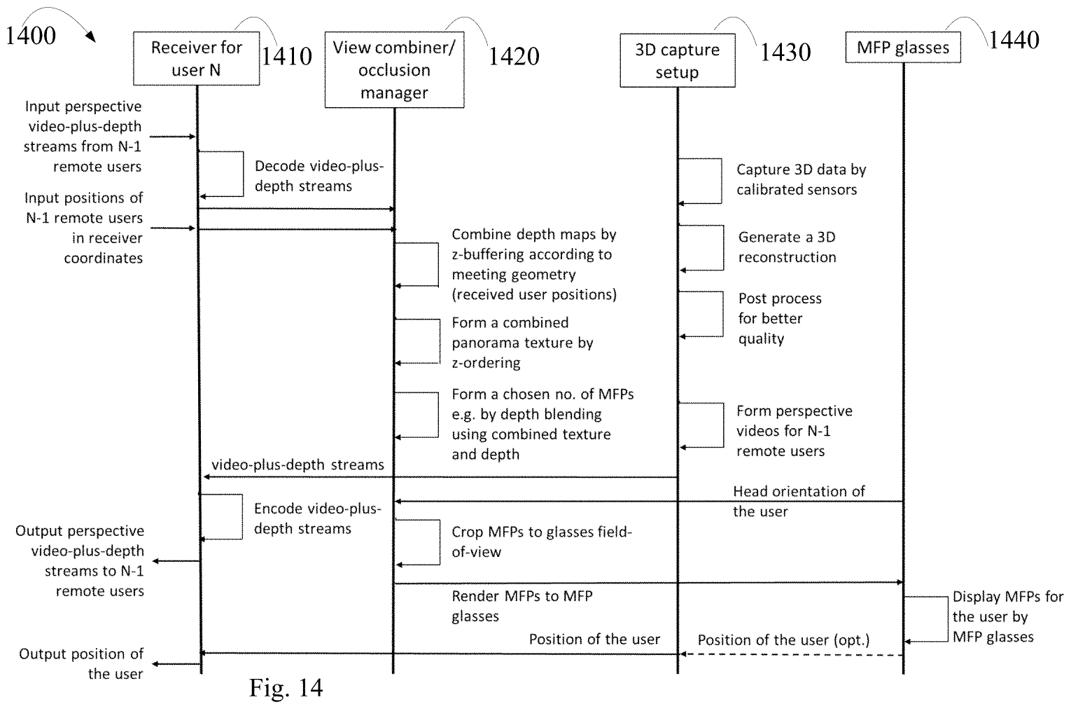

FIG. 14 shows, by way of example, a sequence diagram 1400 for a spatially faithful telepresence terminal with occlusion and accommodation support. The receiver terminal 1410, or receiver module, may comprise the view combiner 1420, the 3D capture setup 1430 and the MFP glasses 1440.

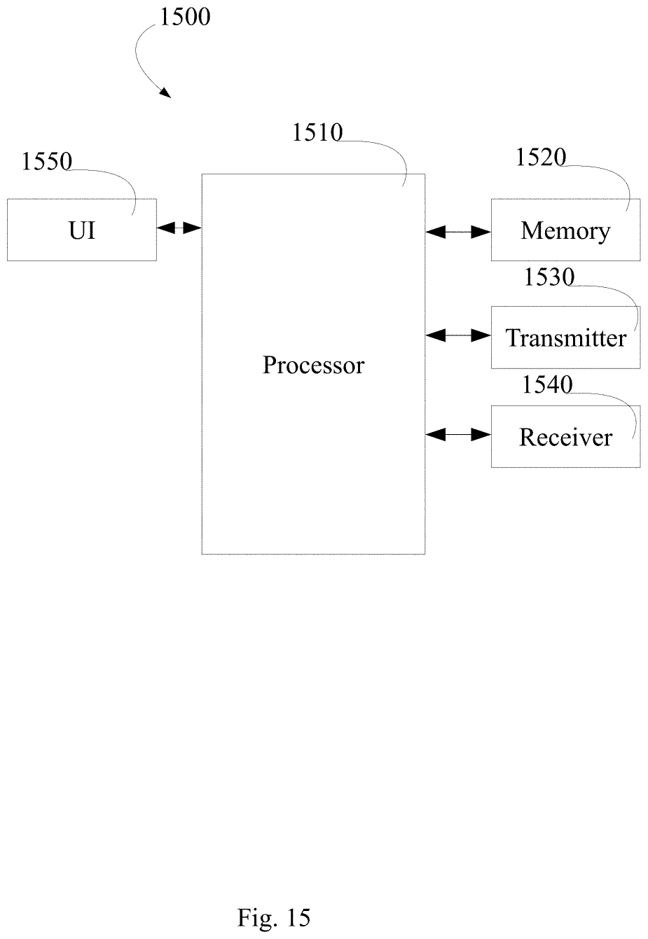

FIG. 15 shows, by way of example, a block diagram of an apparatus 1500. The apparatus may be the receiver module or the transmitter module. Comprised in apparatus 1500 is processor 1510, which may comprise, for example, a single- or multi-core processor wherein a single-core processor comprises one processing core and a multi-core processor comprises more than one processing core. Processor 1510 may comprise, in general, a control device. Processor 1510 may comprise more than one processor. Processor 1510 may be a control device. Processor 1510 may be means for performing method steps in apparatus 1500. Processor 1510 may be configured, at least in part by computer instructions, to perform actions.

Apparatus 1500 may comprise memory 1520. Memory 1520 may comprise random-access memory and/or permanent memory. Memory 1520 may comprise at least one RAM chip. Memory 1520 may comprise solid-state, magnetic, optical and/or holographic memory, for example. Memory 1520 may be at least in part accessible to processor 1510. Memory 1520 may be at least in part comprised in processor 1510. Memory 320 may be means for storing information. Memory 1520 may comprise computer instructions that processor 1510 is configured to execute. When computer instructions configured to cause processor 1510 to perform certain actions are stored in memory 320, and apparatus 1500 overall is configured to run under the direction of processor 1510 using computer instructions from memory 1520, processor 1510 and/or its at least one processing core may be considered to be configured to perform said certain actions. Memory 1520 may be at least in part external to apparatus 1500 but accessible to apparatus 1500.

Apparatus 1500 may comprise a transmitter 1530. Apparatus 1500 may comprise a receiver 1540. Transmitter 1530 and receiver 1540 may be configured to transmit and receive, respectively, information in accordance with at least one wireless or cellular or non-cellular standard. Transmitter 1530 may comprise more than one transmitter. Receiver 1540 may comprise more than one receiver. Transmitter 1530 and/or receiver 1540 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Apparatus 1500 may comprise user interface, UI, 1550. UI 1550 may comprise at least one of a display, a keyboard, a touchscreen, a vibrator arranged to signal to a user by causing apparatus 1500 to vibrate, a speaker and a microphone. A user may be able to operate apparatus 1500 via UI 1550.

Supporting viewpoints on-demand and using video-plus-depth streaming reduces required bitrates compared to solutions based on e.g. transmitting real-time 3D models or light-fields. To enable streaming of user views on-demand, the disclosed system may be designed for low latencies. The disclosed system supports straightforwardly glasses with any number of MFPs. Correspondingly, it is flexible to the progress in development of optical see-through MFP glasses, which is particularly challenged by achieving small enough form factor, with high enough no. of MFPs. The disclosed system supports virtual viewpoints for motion parallax, and synthesizing disparity for any stereo baseline and head tilt. Further, the disclosed system includes support for natural occlusions, e.g. mutual occlusions, between physical and virtual objects.

Additional functionalities include for example supporting of virtual visits between participant spaces, as well as forming expandable landscapes from captured meeting spaces. For example, users may adjust, visit, navigate, and interact inside dynamic spatially faithful geometries; large, photorealistic, spatially faithful geometries may be formed by combining large number of 3D captured sites and users; user mobility is better supported and meeting space mobility is possible, as moving of virtual renderings of physical spaces is not restricted by physical constraints.

1. A method comprising:
receiving, at a local site, one or more perspective video-plus-depth streams from one or more remote sites, the video-plus-depth streams comprising video data and corresponding depth data from a viewpoint of a user at the local site, wherein the local site and the one or more remote sites represent participants of a telepresence session;
decoding the one or more perspective video-plus-depth streams;
receiving a unified virtual geometry determining at least positions of participants at the local site and the one or more remote sites;
forming a combined panorama based on the decoded one or more perspective video-plus-depth streams and the unified virtual geometry; and
forming a plurality of focal planes based on the combined panorama and the depth data; and
rendering the plurality of focal planes for display.

2. (canceled)

3. The method according to claim 1, further comprising
receiving head orientation data of a user at the local site; and
cropping the plurality of focal planes based on the head orientation.

4. The method according to claim 1, wherein
forming the combined panorama comprises z-buffering the depth data and z-ordering the video data.

5. The method according to 1, further comprising receiving one or more texture-plus-depth representations of an AR object; and
forming the combined panorama further based on the texture-plus-depth representation of the AR object.

6. The method according to claim 1, further comprising capturing at least depth data of a foreground object at a local site; and
forming the combined panorama further based on the depth data of the foreground object.

7. The method according to claim 1, further comprising receiving an updated unified virtual geometry, wherein position of at least one participant has been changed; and
forming the combined panorama based on the decoded one or more perspective video-plus-depth streams and the updated unified virtual geometry.

8. The method according to claim 1, further comprising
capturing a plurality of video-plus-depth streams from different viewpoints towards the user at the local site, the video-plus-depth streams comprising video data and corresponding depth data;
forming, in response to a request received from the one or more remote sites, perspective video-plus-depth streams from a viewpoint of a user of the one or more remote site based on the captured video-plus-depth streams and the unified virtual geometry; and
coding and transmitting the perspective video-plus-depth streams to the one or more remote sites and/or to a server; or
forming a multi-view-plus-depth stream based on the perspective video-plus-depth streams and coding and transmitting the multi-view-plus-depth stream to a server.

9. The method according to claim 1, further comprising
tracking position of the user at the local site;
providing the tracked position for generation of the unified virtual geometry.

10. An apparatus comprising at least one processor; and at least one memory including computer program code, the at least one memory and the computer program code configured to, with the at least one processor, cause the apparatus to perform at least:
receiving, at a local site, one or more perspective video-plus-depth streams from one or more remote sites, the video-plus-depth streams comprising video data and corresponding depth data from a viewpoint of a user at the local site, wherein the local site and the one or more remote sites represent participants of a telepresence session;
decoding the one or more perspective video-plus-depth streams;
receiving a unified virtual geometry determining at least positions of participants at the local site and the one or more remote sites;
forming a combined panorama based on the decoded one or more perspective video-plus-depth streams and the unified virtual geometry; and
forming a plurality of focal planes based on the combined panorama and the depth data; and
rendering the plurality of focal planes for display.

11. The apparatus according to claim 10, further configured to perform:
capturing, from the viewpoint of the user at the local site, at least depth data of the local site, and wherein the forming of the combined panorama is further based on the depth data of the local site.

12. (canceled)

13. (canceled)

14. A non-transitory computer readable medium comprising program instructions that, when executed by at least one processor, cause an apparatus to at least to perform:
receiving, at a local site, one or more perspective video-plus-depth streams from one or more remote sites, the video-plus-depth streams comprising video data and corresponding depth data from a viewpoint of a user at the local site, wherein the local site and the one or more remote sites represent participants of a telepresence session;
decoding the one or more perspective video-plus-depth streams;
receiving a unified virtual geometry determining at least positions of participants at the local site and the one or more remote sites;
forming a combined panorama based on the decoded one or more perspective video-plus-depth streams and the unified virtual geometry; and
forming a plurality of focal planes based on the combined panorama and the depth data; and
rendering the plurality of focal planes for display.

15. The non-transitory computer readable medium according to claim 14,
wherein the plurality of focal planes is rendered to a wearable multifocal plane display.

16. The method according to claim 1, wherein the plurality of focal planes is rendered to a wearable multifocal plane display.

17. The non-transitory computer readable medium according to claim 14, comprising program instructions that, when executed by at least one processor, cause the apparatus to at least to perform:
receiving one or more texture-plus-depth representations of an AR object; and
forming the combined panorama further based on the texture-plus-depth representation of the AR object.

18. The non-transitory computer readable medium according to claim 14, comprising program instructions that, when executed by at least one processor, cause the apparatus to at least to perform:
capturing a plurality of video-plus-depth streams from different viewpoints towards the user at the local site, the video-plus-depth streams comprising video data and corresponding depth data;
forming, in response to a request received from the one or more remote sites, perspective video-plus-depth streams from a viewpoint of a user of the one or more remote site based on the captured video-plus-depth streams and the unified virtual geometry; and
coding and transmitting the perspective video-plus-depth streams to the one or more remote sites and/or to a server; or
forming a multi-view-plus-depth stream based on the perspective video-plus-depth streams and coding and transmitting the multi-view-plus-depth stream to a server.

19. The non-transitory computer readable medium according to claim 14, comprising program instructions that, when executed by at least one processor, cause the apparatus to at least to perform:
capturing, from the viewpoint of the user at the local site, at least depth data of the local site, and wherein the forming of the combined panorama is further based on the depth data of the local site.

20. The method according to claim 1, further comprising capturing, from the viewpoint of the user at the local site, at least depth data of the local site, and wherein the forming of the combined panorama is further based on the depth data of the local site.

21. The apparatus according to claim 10, wherein the plurality of focal planes is rendered to a wearable multifocal plane display.

22. The apparatus according to claim 10, further configured to perform:
receiving one or more texture-plus-depth representations of an AR object; and
forming the combined panorama further based on the texture-plus-depth representation of the AR object.

23. The apparatus according to claim 10, further configured to perform:
capturing a plurality of video-plus-depth streams from different viewpoints towards the user at the local site, the video-plus-depth streams comprising video data and corresponding depth data;
forming, in response to a request received from the one or more remote sites, perspective video-plus-depth streams from a viewpoint of a user of the one or more remote site based on the captured video-plus-depth streams and the unified virtual geometry; and
coding and transmitting the perspective video-plus-depth streams to the one or more remote sites and/or to a server; or
forming a multi-view-plus-depth stream based on the perspective video-plus-depth streams and coding and transmitting the multi-view-plus-depth stream to a server.
